(19) United States
(12) Patent Application Publication
(10) Pub. No.: US 2025/0192315 A1
(43) Pub. Date: Jun. 12, 2025

(54) BATTERY PACK AND ROBOT COMPRISING THE SAME

(71) Applicant: HL MANDO CORPORATION, Pyeongtaek (KR)

(72) Inventors: Jeongjae PARK, Pyeongtaek (KR); Dongseon KIM, Pyeongtaek (KR); Oseok KWON, Pyeongtaek (KR)

(21) Appl. No.: 18/972,504

(22) Filed: Dec. 6, 2024

(30) Foreign Application Priority Data
Dec. 7, 2023 (KR) 10-2023-0176750
Nov. 12, 2024 (KR) 10-2024-0160467

(51) Int. Cl. H01M 50/258; B25J 19/00; H01M 50/209

(52) U.S. Cl. CPC H01M 50/258; B25J 19/005; H01M 50/209

(57) ABSTRACT

A battery pack and a robot including the same are disclosed.

The battery pack includes a battery; a housing in which the battery is disposed, and comprising an upper surface, a lower surface, and a plurality of side surfaces; a connector having a terminal connecting the battery to the outside of the battery and connected to the housing; and an extension portion extending outward from the upper surface of the housing than the plurality of side surface.

### CROSS-REFERENCE TO RELATED APPLICATION

This application claims priority to and benefit from Korean Patent Applications No. 10-2023-0176750, filed on Dec. 7, 2023 and No. 10-2024-0160467, filed on Nov. 12, 2024, the disclosures of which are incorporated herein by reference in their entirety.

### TECHNICAL FIELD

The present disclosure relates to a battery pack and a robot including the same, and more particularly, to a battery pack providing electric power to a robot or the like and a robot including the same.

### RELATED ART

The battery pack is composed of one pack by connecting a plurality of battery cells. The battery pack may easily realize high power, high capacity, and the like by providing a plurality of battery cells as one pack.

The battery pack is installed and used in an apparatus such as robots and electric vehicles. In this regard, it is necessary to facilitate installation, removal, and replacement of the battery pack. In addition, due to the appearance of low-rise parking robots, etc., when a battery pack is installed in an apparatus it is also required to minimize the increase in the height of the apparatus due to the installation of the battery pack.

### SUMMARY

The present disclosure is to solve the above problems, and the present disclosure is directed to providing a battery pack that can be easily mounted in an apparatus such as a robot and the like, and a robot including the same.

The present disclosure is also directed to providing a battery pack and a robot including the same in which when installing the battery pack in an apparatus, an increase in the height of the apparatus due to the installation of the battery pack is minimized.

The objects of the present disclosure are not limited to the above-described objects, and other objects that are not mentioned will be able to be clearly understood by those skilled in the art to which the present disclosure pertains from the following description.

According to an aspect of the present disclosure, provided is a battery pack, including a battery; a housing in which the battery is disposed, and comprising an upper surface, a lower surface, and a plurality of side surfaces; a connector having a terminal connecting the battery to the outside of the battery and connected to the housing; and an extension portion extending outward from the upper surface of the housing than the plurality of side surface.

In the battery pack according to an aspect of the present disclosure, the extension portion may be continuously arranged surrounding the upper surface.

In the battery pack according to an aspect of the present disclosure, the extension portion may extend at a uniform distance from the upper surface.

In the battery pack according to an aspect of the present disclosure, the upper surface of the housing may have a rectangular plate shape.

In the battery pack according to an aspect of the present disclosure, one side surface of the plurality of side surfaces may have a protruding structure in which an upper part protrudes outward compared to a lower part, and the connector may be arranged on the one side surface having the protruding structure.

In the battery pack according to an aspect of the present disclosure, the one side surface having the protruding structure may include a lower side surface, an upper side surface arranged at a position protruding outward compared to the lower side surface, and a connection surface extending to connect the lower side surface and the upper side surface, and the connector may be arranged on the connection surface.

In the battery pack according to an aspect of the present disclosure, the connector may be arranged at the center of the connection surface.

In the battery pack according to an aspect of the present disclosure, the connector may be arranged so that the terminal faces downward.

According to another aspect of the present disclosure, provided is a robot, including a battery pack, comprising: a battery; a housing in which the battery is disposed, and comprising an upper surface, a lower surface, and a plurality of side surfaces; a connector having a terminal connecting the battery to the outside of the battery and connected to the housing; and an extension portion extending outward from the upper surface of the housing than the plurality of side surface; and a body, comprising: a corresponding terminal connected to the terminal, and an installation hole in which the battery pack is installed, wherein a corresponding connector fastened to the connector is arranged in the body, wherein the battery pack is inserted into the installation hole, and the extension portion is fixed to the body while hanging over an upper edge of a boundary of the installation hole.

In the robot according to another aspect of the present disclosure, the installation hole may have an upper side open, and the battery pack may be fixed to the body by its own weight while the extension portion hangs over a boundary of the installation hole.

In the robot according to another aspect of the present disclosure, the extension portion may be continuously arranged surrounding the upper surface.

In the robot according to another aspect of the present disclosure, the extension portion may extend at a uniform distance from the upper surface.

In the robot according to another aspect of the present disclosure, the upper surface of the housing may have a rectangular plate shape.

In the robot according to another aspect of the present disclosure, at least a part of an upper edge of a boundary of the installation hole contacting the extension portion may be formed to be lower than the outer side with respect to the installation hole.

In the robot according to another aspect of the present disclosure, at least a part of an upper edge of a boundary of the installation hole contacting the extension portion may be formed to be lower by the thickness or more of the extension portion than the outer side with respect to the installation hole.

In the robot according to another aspect of the present disclosure, one side surface of the plurality of side surfaces of the housing may have a protruding structure in which an upper part protrudes outward compared to a lower part, and the connector may be arranged on the one side surface having the protruding structure.

In the robot according to another aspect of the present disclosure, the one side surface having the protruding structure may include a lower side surface, an upper side surface arranged at a position protruding outward compared to the lower side surface, and a connection surface extending to connect the lower side surface and the upper side surface, and the connector may be arranged on the connection surface.

In the robot according to another aspect of the present disclosure, the connector may be arranged at the center of the connection surface.

In the robot according to another aspect of the present disclosure, the connector may be arranged so that the terminal faces downward, and the corresponding connector may be arranged so that the corresponding terminal faces upward.

In the robot according to another aspect of the present disclosure, when the battery pack is inserted into the installation hole, the connector and the corresponding connector may be fastened by the weight of the battery pack.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view illustrating a battery pack viewed from the top according to an exemplary embodiment of the present disclosure;

FIG. 2 is a perspective view illustrating a battery pack viewed from the bottom according to an exemplary embodiment of the present disclosure;

FIG. 3 is a side view of a battery pack according to an exemplary embodiment of the present disclosure;

FIG. 4 is a view illustrating a configuration of a robot according to an exemplary embodiment of the present disclosure;

FIG. 5 is a view illustrating a robot from which a battery pack is separated according to an exemplary embodiment of the present disclosure;

FIG. 6 is a view illustrating a corresponding connector disposed on a body of a robot according to an exemplary embodiment of the present disclosure;

FIG. 7 is a view illustrating a state before a battery pack is inserted into an installation hole of a body of a robot according to an exemplary embodiment of the present disclosure; and

FIG. 8 is a view illustrating a state in which a battery pack is inserted into an installation hole of a body of a robot according to an exemplary embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

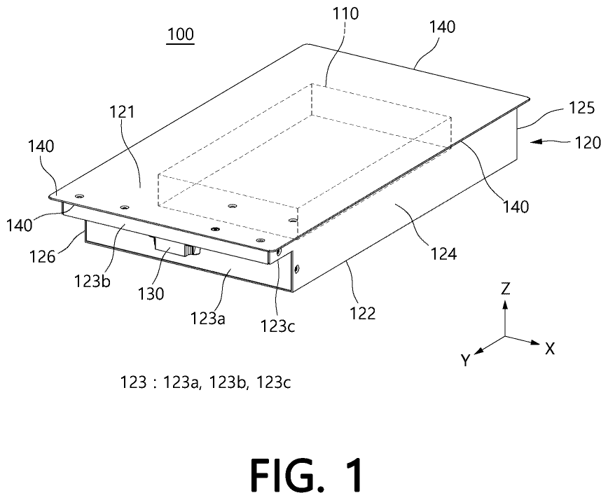

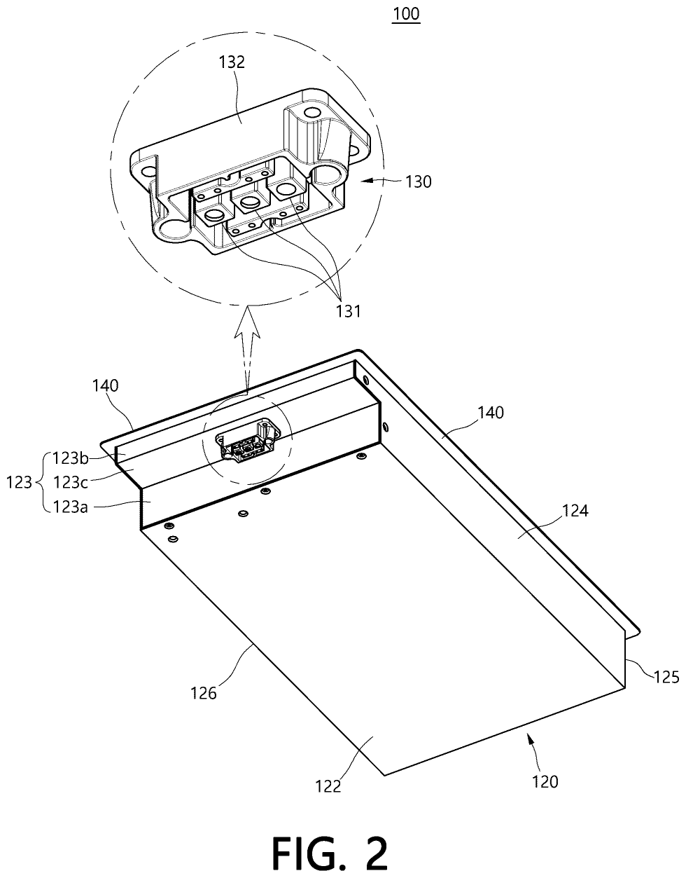

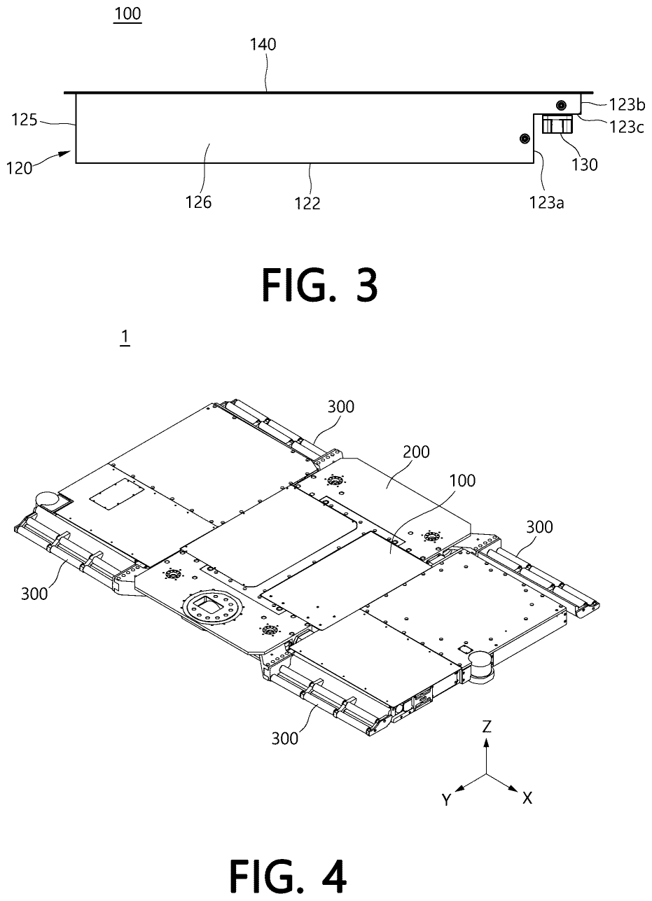

FIG. 1 is a perspective view illustrating a battery pack viewed from the top according to an exemplary embodiment of the present disclosure. FIG. 2 is a perspective view illustrating a battery pack viewed from the bottom according to an exemplary embodiment of the present disclosure. FIG. 3 is a side view of a battery pack according to an exemplary embodiment of the present disclosure.

The battery pack 100 according to an exemplary embodiment of the present disclosure is mounted in an apparatus that requires electric power and provides electric power to the apparatus. The battery pack 100 may provide the power, charging, and discharging capacity required by the apparatus. For example, the apparatus may be a robot, an electric vehicle, other power machine, or the like.

Referring to FIGS. 1 to 3, the battery pack 100 according to an exemplary embodiment of the present disclosure includes a battery 110, a housing 120, and a connector 130.

The battery 110 generates electric energy. The electric energy generated by the battery 110 may be used as a power source for an apparatus in which the battery pack 100 is installed.

The battery 110 may be configured as a secondary battery capable of charging and discharging. For example, the battery 110 may be a lithium ion battery, a lithium iron phosphate battery, or the like. Of course, the type of battery 110 is not limited by the example.

The housing 120 forms the exterior of the battery pack 100. In an embodiment of the present disclosure, the housing 120 may have a rectangular box shape. More specifically, the housing 120 may have an approximately rectangular parallelepiped shape.

The housing 120 accommodates the battery 110. In other words, the battery 110 may be disposed inside the housing 120. The housing 120 protects the battery 110 disposed therein from external impact. In addition, the housing 120 prevents foreign substances such as moisture and dust from entering the battery 110.

The housing 120 may be a rigid body. For example, the housing 120 may include a metal material.

In an embodiment of the present disclosure, the housing 120 includes an upper surface 121, a lower surface 122, and a plurality of side surfaces 123, 124, 125, and 126.

The upper surface 121 may have a horizontal plate shape. In an embodiment of the present disclosure, the upper surface 121 has a quadrilateral plate shape. More specifically, the upper surface 121 has a rectangular plate shape.

Referring to FIG. 1, the upper surface 121 is disposed parallel to the XY plane.

The lower surface 122 is spaced apart from the lower side of the upper surface 121 to face the upper surface 121. The lower surface 122 may have a horizontal plate shape. In an embodiment of the present disclosure, the lower surface 122 has a quadrilateral plate shape. More specifically, the lower surface 122 has a rectangular plate shape.

Referring to FIG. 1, the lower surface 122 is disposed parallel to the XY plane.

The plurality of side surfaces 123, 124, 125, and 126 are disposed to connect the upper surface 121 and the lower surface 122. The plurality of side surfaces 123, 124, 125, and 126 may form a closed region between the upper surface 121 and the lower surface 122. More specifically, the plurality of side surfaces 123, 124, 125, and 126 may form a rectangular box-shaped closed region between the upper surface 121 and the lower surface 122.

In an embodiment of the present disclosure, the plurality of side surface 123, 124, 125, and 126 may include a first side surface 123, a second side surface 124, a third side surface 125, and a fourth side surface 126.

The first side surface 123 and the third side surface 125 extend in the first direction (a direction parallel to the X-axis in FIG. 1). The first side surface 123 and the third side surface 125 may be disposed to face each other.

Referring to FIG. 1, the first side surface 123 and the third side surface 125 are disposed parallel to the XZ plane.

The second side surface 124 and the fourth side surface 126 extend in the second direction (a direction parallel to the Y-axis in FIG. 1) orthogonal to the first direction. The second side surface 124 and the fourth side surface 126 may be disposed to face each other.

Referring to FIG. 1, the second side surface 124 and the fourth side surface 126 are disposed parallel to the YZ plane.

Meanwhile, the first side surface 123, the second side surface 124, the third side surface 125, and the fourth side surface 126 may all have the same height.

One of the plurality of side surfaces 123, 124, 125, and 126 may have a protruding structure in which an upper part protrudes outward compared to a lower part. In an embodiment of the present disclosure, among the first side surface 123, the second side surface 124, the third side surface 125, and the fourth side surface 126, the first side surface 123 may have a protruding structure in which an upper part protrudes outward compared to a lower part.

The first side surface 123 having a protruding structure includes a lower side surface 123a, an upper side surface 123b disposed at a position protruding outward compared to the lower side surface 123a, and a connection surface 123c extending by connecting the lower side surface 123a and the upper side surface 123b.

In this case, the connection surface 123c may be orthogonal to the lower side surface 123a and the upper surface 123b, respectively. In addition, the connection surface 123c may be disposed in parallel with the upper surface 121 and the lower surface 122.

Referring to FIG. 1, the lower side surface 123a and the upper side surface 123b may be disposed parallel to the XZ plane, and the connection surface 123c may be disposed parallel to the XY plane.

The connector 130 connects the battery 110 to the outside. Electric power of the battery 110 may be supplied to the outside through the connector 130.

External electric power may be supplied to charge the battery 110 through the connector 130. In addition, a control signal for managing the battery 110 may be transmitted through the connector 130.

The connector 130 has a terminal 131 connecting the battery 110 to the outside and is connected to the housing 120. The connector 130 may further include a connector housing 132 in which the terminal 131 is disposed. The connector housing 132 may be disposed to surround the terminal 131.

The connector 130 may be disposed such that the terminal 131 faces downward. In this case, the connector housing 132 may have a shape surrounding side surfaces of the terminal 131, and a lower side thereof may be open.

When the terminal 131 of the connector 130 has an orientation toward the lower side, the connector 130 may be easily fastened with the corresponding connector by the weight of the battery pack 100. That is, since the terminal 131 of the connector 130 has an orientation toward the lower side, the connector 130 may be easily fastened by the weight of the battery pack 100.

The connector 130 may be disposed on one side surface having the protruding structure among the plurality of side surfaces 123, 124, 125, and 126. In an embodiment of the present disclosure, the connector 130 is disposed on the first side surface 123.

As described above, the first side surface 123 includes a lower side surface 123a, an upper side surface 123b disposed at a position protruding outward compared to the lower side surface 123a, and a connection surface 123c extending by connecting the lower side surface 123a and the upper side surface 123b.

In this case, the connector 130 may be disposed on the connection surface 123c. More specifically, the connector 130 may be disposed at the center of the connection surface 123c.

The connector 130 may be disposed such that the terminal 131 faces downward from the connection surface 123c. Since the connection surface 123c is disposed parallel to the upper surface 121 and the lower surface 122, when the connector 130 is disposed on the connection surface 123c, it is easy to allow the orientation of the terminal 131 to face downward.

An extension portion 140 is disposed to extend the upper surface 121 of the housing 120 outwardly from the plurality of side surfaces 123, 124, 125, and 126. The extension portion 140 provides a structure in which the upper end of the battery pack 100 extends to the outside of the housing 120.

The extension portion 140 allows the battery pack 100 to be fixed while being caught eternally. When the battery pack 100 is inserted into an installation hole provided in an apparatus such as a robot, the extension portion 140 is caught on the boundary of the installation hole and the battery pack 100 may be fixed.

In an embodiment of the present disclosure, the upper surface 121 has a rectangular plate shape, and the extension portion 140 may extend outward from each edge of the upper surface 121 than the first side surface 123, the second side surface 124, the third side surface 125, and the fourth side surface 126.

The extension portion 140 may be continuously disposed surrounding the upper surface 121. In an embodiment of the present disclosure, the extension portion 140 may be disposed to entirely surround the upper surface 121 of the rectangular plate shape.

As such, the extension portion 140 is continuously arranged surrounding the upper surface 121, and thus, when the battery pack 100 is installed in an external apparatus, a locking structure that hangs over the external apparatus may be entirely formed along the upper end of the housing 120.

The extension portion 140 may extend at a uniform distance from the upper surface 121. Since the extension portion 140 extends at a uniform distance from the upper surface 121, when the battery pack 100 is installed in an external apparatus, it is possible to prevent a support force generated d over the external apparatus from concentrating on a specific part of the extension portion 140.

The stress acting on the extension portion 140 is efficiently dispersed through a configuration in which the extension portion 140 surrounds the upper surface 121 and is generally arranged, and the extension portion 140 extends at a uniform distance from the upper surface 121. Accordingly, durability of the battery pack 100 may be improved.

The extension portion 140 may be integrally formed with the housing 120. More specifically, the extension portion 140 may be integrally formed with the upper surface 121.

The extension portion 140 may be formed of the same material as the housing 120. For example, the extension 140 may include a metal material.

As described above, the battery pack 100 according to an exemplary embodiment of the present disclosure has been described in detail. Hereinafter, a robot 1 according to an exemplary embodiment of the present disclosure will be described.

FIG. 4 is a view illustrating a configuration of a robot according to an exemplary embodiment of the present disclosure. FIG.

5 is a view illustrating a robot from which a battery pack is separated according to an exemplary embodiment of the present disclosure.

The robot 1 according to an exemplary embodiment of the present disclosure may receive electric power from the battery pack 100 to perform work. For example, the robot 1 may move a vehicle to be parked in a parking spot or pull out a vehicle parked in the parking spot. More specifically, the robot 1 is configured in a low-floor robot, and is capable of moving by lifting one or more wheels of a vehicle to be parked.

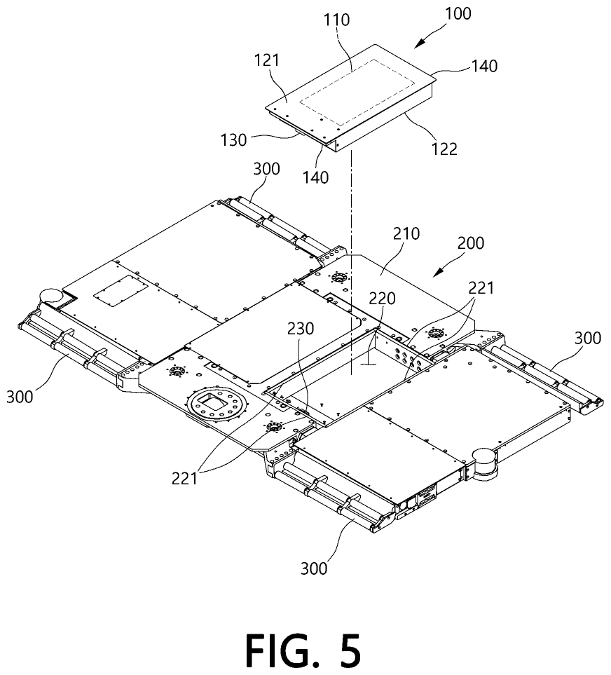

Referring to FIG. 4 and FIG. 5, the robot 1 according to an exemplary embodiment of the present disclosure includes a battery pack 100 and a body 200.

The battery pack 100 includes a battery 110, a housing 120, a connector 130, and an extension portion 140.

The battery 110, the housing 120, the connector 130, and the extension portion 140 are the same as described in relation to the battery pack 100 according to an exemplary embodiment of the present disclosure. Thus, with respect to the battery pack 100, detailed descriptions of respective components will be omitted.

The body 200 forms a skeleton of the robot 1. The body 200 may include one or more body elements 210. For example, the body element 210 may be a frame, a plate, or the like.

The body 200 may have a plate shape as a whole. As described above, the robot 1 is configured in a low-floor type to lift the wheels of a vehicle and move the vehicle, which requires the robot 1 to enter the lower part of the vehicle. In this regard, the body 200 may have a plate shape.

Referring to FIG. 4, the body 200 may have a shape extending on a plane parallel to the XY plane.

The battery pack 100 is installed in the body 200. As shown in FIG. 5, the body 200 includes an installation hole 220 in which the battery pack 100 is installed.

The upper side of the installation hole 220 is open. Accordingly, when the battery pack 100 is inserted into the installation hole 220, the extension portion 140 may hang over the upper edge 221 of the boundary of the installation hole 220 and the battery pack 100 may be fixed to the body 200. In other words, in the battery pack 100, the extension portion 140 may hang over the boundary of the installation hole 220 and may be fixed to the body 200 by its own weight.

The installation hole 220 may have a shape corresponding to the shape of the housing 120 of the battery pack 100. As described above, the housing 120 of the battery pack 100 may have a rectangular box shape, and the installation hole 220 may have a rectangular box shape corresponding thereto.

The installation hole 220 may have a shape penetrating vertically. Alternatively, the installation hole 220 may have a structure in which the lower end is closed.

In an embodiment of the present disclosure, the extension portion 140 of the battery pack 100 is continuously arranged surrounding the upper surface 121 of the housing 120 of the battery pack 100. More specifically, the extension portion 140 may be disposed to entirely surround the upper surface 121 of the rectangular plate shape.

Accordingly, the battery pack 100 is fixed to the body 200 while entirely hanging over the upper edge 221 of the boundary of the installation hole 220. Due to this structure, the battery pack 100 may be stably fixed to the body 200.

In addition, in an embodiment of the present disclosure, the extension portion 140 of the battery pack 100 may extend at a uniform distance from the upper surface 121. Accordingly, the extension portion 140 hanging over the upper edge 221 of the boundary of the installation hole 220 may efficiently distribute stress.

In this way, the structure in which the extension portion 140 surrounds the upper surface 121 and is generally arranged and hangs over the upper edge 221 of the boundary of the installation hole 220 and the structure in which the extension portion 140 extends at a uniform distance from the upper surface 121 and uniformly hangs over the upper edge 221 of the boundary of the installation hole 220 efficiently distribute the stress acting on the extension portion 140 when the battery pack 100 is installed in the body 200 of the robot 1. Accordingly, durability of the battery pack 100 may be improved.

At least a part of the upper edge 221 of the boundary of the installation hole 220 contacting the extension portion 140 may be formed to be lower than the outer side with respect to the installation hole 220. For example, at least a part of the upper edge 221 of the boundary of the installation hole 220 may be formed to be lower by the thickness more of the extension portion 140 than the outer side with respect to the installation hole 220.

In an embodiment of the present disclosure, the entire upper edge 221 of the boundary of the installation hole 220 contacting the extension portion 140 is formed to be lower by the thickness of the extension portion 140 than the outer side with respect to the installation hole 220. Accordingly, when the battery pack 100 is inserted into the installation hole 220 and installed in the body 200, a height increase (a length increase in the Z-axis direction based on FIG. 4) due to the installation of the battery pack 100 does not occur.

A corresponding connector 230 is disposed in the body 200. The corresponding connector 230 may be coupled to the connector 130 of the battery pack 100.

In an embodiment of the present disclosure, the corresponding connector 230 may be disposed inside the installation hole 220.

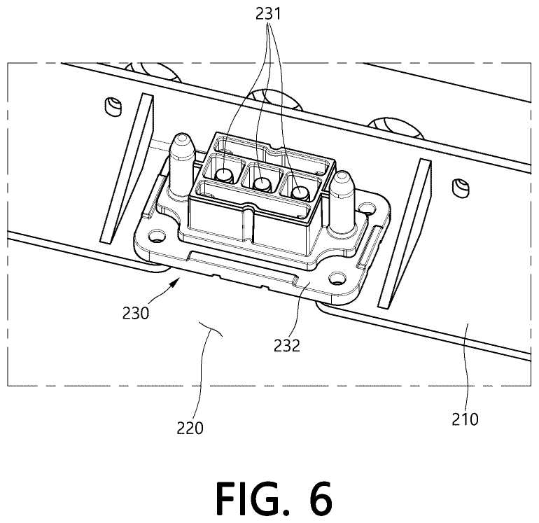

FIG. 6 is a view illustrating a corresponding connector disposed on a body of a robot according to an exemplary embodiment of the present disclosure.

Referring to FIG. 6, the corresponding connector 230 has a corresponding terminal 231 connected to the terminal 131 of the connector 130 of the battery pack 100. In addition, the corresponding connector 230 may further include a corresponding connector housing 232 provided so that the corresponding terminal 231 is disposed therein. The corresponding connector housing 232 may be disposed to surround the corresponding terminal 231.

The corresponding connector 230 may be disposed such that the corresponding terminal 231 faces upward. In this case, the corresponding connector housing 232 may have a shape surrounding side surfaces of the corresponding terminal 231, and an upper side thereof may be open.

Meanwhile, as described above, the connector 130 of the battery pack 100 may be arranged such that the terminal 131 faces downward. Therefore, when the corresponding connector 230 is arranged so that the corresponding terminal 231 faces upward, it can be easily achieved to fasten the connector 130 and the corresponding connector 230 by the weight of the battery pack 100 when the battery pack 100 is installed.

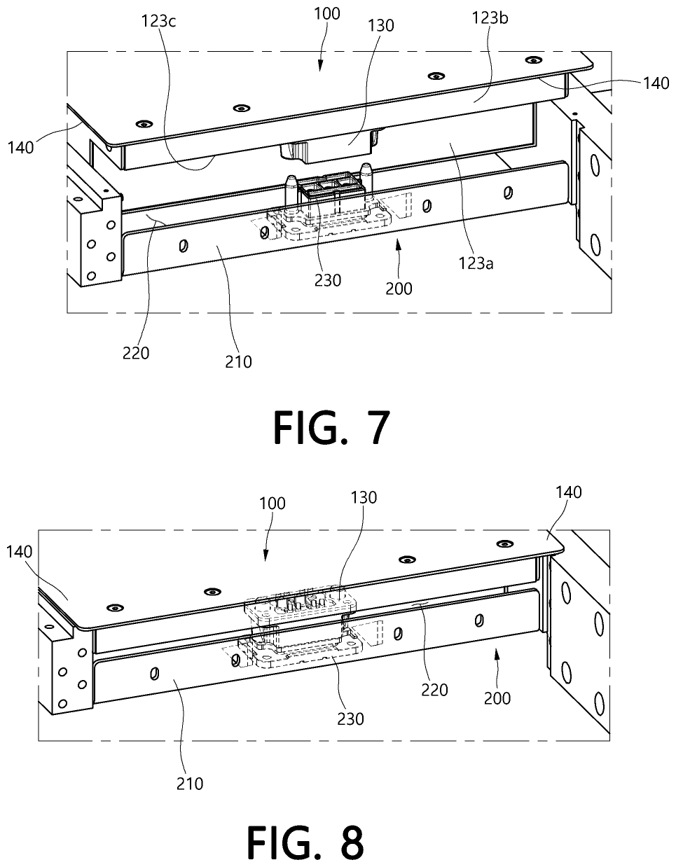

FIG. 7 is a view illustrating a state before a battery pack is inserted into an installation hole of a body of a robot according to an exemplary embodiment of the present disclosure. FIG. 8 is a view illustrating a state in which a battery pack is inserted into an installation hole of a body of a robot according to an exemplary embodiment of the present disclosure.

Referring to FIGS. 7 and 8, the terminal 131 of the connector 130 of the battery pack 100 is disposed to face downward, and the corresponding terminal 231 of the corresponding connector 230 is disposed to face upward, so when the battery pack 100 is inserted into the installation hole 220, the connector 130 and the corresponding connector 230 may be fastened by the weight of the battery pack 100.

Meanwhile, when the battery pack 100 is separated from the body 200 of the robot 1, the connector 130 and the corresponding connector 230 may be separated from each other by the force of lifting the battery pack 100. In other words, in accordance with an exemplary embodiment of the present disclosure, the fastening and separation of the connector 130 and the corresponding connector 230 may be naturally performed during the installation or separation process of the battery pack 100.

The robot 1 provides a detachable structure of the connector 130 and the corresponding connector 230 as described above, so that the battery pack 100 may be installed in the body 200 of the robot 1 or the battery pack 100 may be removed from the body 200 of the robot 1 by utilizing a magnet gripper or the like without a separate structure such as a handle.

In addition, this structure allows the installation or removal of the battery pack 100 through a gantry robot, a scalar robot, or the like. As a result, the manufacturing process efficiency of the robot 1 may be improved.

Referring to FIG. 8, in a state in which the battery pack 100 is inserted into the installation hole 220 and installed in the body 200, a space is formed in the installation hole 220 between the lower surface 122 of the first side surface 123 of the housing 120 of the battery pack 100 and the inner wall of the installation hole 220.

Various wiring (not shown) of the robot 1 may be arranged in the space formed between the lower surface 122 of the first side surface 123 of the housing 120 and the inner wall of the installation hole 220. Accordingly, space efficiency related to the arrangement of various components of the robot 1 may be improved.

Meanwhile, the robot 1 according to an exemplary embodiment of the present disclosure may further include a plurality of lifting arms 300. The plurality of lifting arms 300 are driven by receiving electric power from the battery pack 100.

In this regard, the robot 1 may further include a driving unit (not shown) for driving the plurality of lifting arms 300, a control unit (not shown), and the like. The driving unit and the control unit may be disposed inside the body 200 of the robot 1.

A pair of said lifting arms 300 are disposed on one side and the other side of the body 200, respectively. The plurality of lifting arms 300 shown in FIG. 5 are in a folded state. Each lifting arm 300 may be pivoted and unfolded, respectively, with respect to the body 200 so as to be disposed parallel to the X-axis based on FIG. 5.

The pair of lifting arms 300 disposed on one side of the body 200 may simultaneously lift the wheels of the vehicle in the unfolded state. In addition, the pair of lifting arms 300 disposed on the other side of the body 200 may simultaneously lift the wheels of the vehicle in the unfolded state.

Through the above operation, the robot 1 may simultaneously lift the left front wheel and the right front wheel of the vehicle or simultaneously lift the left rear wheel and the right rear wheel of the vehicle. In other words, in the robot 1 according to an exemplary embodiment of the present disclosure, two robots may operate together in a pair to lift four wheels of one vehicle, and park or pull out the vehicle.

According to the configuration, in a battery pack and a robot including the same according to an aspect of the present disclosure, the battery pack is easily mounted in an apparatus by the extension portion extending from the upper surface of the housing to the outside of the housing.

In addition, in a battery pack and a robot including the same according to an aspect of the present disclosure, through a structure in which the connector is fastened by the weight of the battery pack, the battery pack may be easily attached/detached or replaced.

In addition, a battery pack and a robot including the same according to an aspect of the present disclosure minimizes the increase in the height of the robot due to the installation of the battery pack through a structure in which the extension portion extending from the upper surface of the housing of the battery pack to the outside of the housing hangs over the upper edge of the installation hole of the body and is fixed.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A battery pack, comprising:
a battery;
a housing in which the battery is disposed, and comprising an upper surface, a lower surface, and a plurality of side surfaces;
a connector having a terminal connecting the battery to the outside of the battery and connected to the housing; and
an extension portion extending outward from the upper surface of the housing than the plurality of side surface.

2. The battery pack of claim 1, wherein the extension portion is continuously arranged surrounding the upper surface.

3. The battery pack of claim 1, wherein the extension portion extends at a uniform distance from the upper surface.

4. The battery pack of claim 1, wherein the upper surface of the housing has a rectangular plate shape.

5. The battery pack of claim 1,
wherein one side surface of the plurality of side surfaces has a protruding structure in which an upper part protrudes outward compared to a lower part, and
wherein the connector is arranged on the one side surface having the protruding structure.

6. The battery pack of claim 5,
wherein the one side surface having the protruding structure comprises a lower side surface, an upper side surface arranged at a position protruding outward compared to the lower side surface, and a connection surface extending to connect the lower side surface and the upper side surface, and
wherein the connector is arranged on the connection surface.

7. The battery pack of claim 6, wherein the connector is arranged at the center of the connection surface.

8. The battery pack of claim 6, wherein the connector is arranged so that the terminal faces downward.

9. A robot, comprising:
a battery pack, comprising: a battery; a housing in which the battery is disposed, and comprising an upper surface, a lower surface, and a plurality of side surfaces; a connector having a terminal connecting the battery to the outside of the battery and connected to the housing; and an extension portion extending outward from the upper surface of the housing than the plurality of side surface; and
a body, comprising: a corresponding terminal connected to the terminal, and an installation hole in which the battery pack is installed, wherein a corresponding connector fastened to the connector is arranged in the body,
wherein the battery pack is inserted into the installation hole, and the extension portion is fixed to the body while hanging over an upper edge of a boundary of the installation hole.

10. The robot of claim 9, wherein the installation hole has an upper side open, and the battery pack is fixed to the body by its own weight while the extension portion hangs over a boundary of the installation hole.

11. The robot of claim 9, wherein the extension portion is continuously arranged surrounding the upper surface.

12. The robot of claim 9, wherein the extension portion extends at a uniform distance from the upper surface.

13. The robot of claim 9, wherein the upper surface of the housing has a rectangular plate shape.

14. The robot of claim 9, wherein at least a part of an upper edge of a boundary of the installation hole contacting the extension portion is formed to be lower than the outer side with respect to the installation hole.

15. The robot of claim 9, wherein at least a part of an upper edge of a boundary of the installation hole contacting the extension portion is formed to be lower by the thickness or more of the extension portion than the outer side with respect to the installation hole.

16. The robot of claim 9,
wherein one side surface of the plurality of side surfaces of the housing has a protruding structure in which an upper part protrudes outward compared to a lower part, and
wherein the connector is arranged on the one side surface having the protruding structure.

17. The robot of claim 16,
wherein the one side surface having the protruding structure comprises a lower side surface, an upper side surface arranged at a position protruding outward compared to the lower side surface, and a connection surface extending to connect the lower side surface and the upper side surface, and
wherein the connector is arranged on the connection surface.

18. The robot of claim 17, wherein the connector is arranged at the center of the connection surface.

19. The robot of claim 17, wherein the connector is arranged so that the terminal faces downward, and the corresponding connector is arranged so that the corresponding terminal faces upward.

20. The robot of claim 19, wherein when the battery pack is inserted into the installation hole, the connector and the corresponding connector are fastened by the weight of the battery pack.
